(19) United States
(12) Patent Application Publication
(10) Pub. No.: US 2014/0057702 A1
(43) Pub. Date: Feb. 27, 2014

(54) System and Method for Providing a Mystery Prize

(71) Applicant: BALLY GAMING, INC, Las Vegas, NV (US)

(72) Inventors: Mark Lowell, Reno, NV (US); Will Jones, Incline Village, NV (US)

(73) Assignee: Bally Gaming, Inc, Las Vegas, NV (US)

(21) Appl. No.: 13/859,930

(22) Filed: Apr. 10, 2013

Related U.S. Application Data
(60) Provisional application No. 61/691,928, filed on Aug. 22, 2012.

(51) Int. Cl. G07F 17/32

(52) U.S. Cl. CPC G07F 17/3244
USPC 463/25

(57) ABSTRACT

A system and method are set forth for offering a mystery award amongst a plurality of gaming devices. Based upon the play of a base game, the players are provided with an initial instance of a mystery game presentation such as a Bingo card. Players may increase their chances of winning by acquiring, for value, addition Bingo cards to be played with each base game play. For each base game play a determination is made as to whether a predetermined trigger condition has been satisfied. If it has the host computer sends a signal to a local controller to control one or more winning game instances to display a winning sequence to accompany and award. If the trigger condition is not satisfied, the local controller controls the display to display losing game sequences. Various trigger conditions may be used including basing a trigger on odds related to the game instance type. The game instance type can be Bingo, Keno, Poker, a sporting event or other event.

### CROSS-REFERENCE TO RELATED APPLICATION

This application claims the benefit of and priority to prior filed U.S. provisional patent application Ser. No. 61/691,928 filed Aug. 22, 2012 and titled “A System and Method for Providing a Mystery Prize”.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The field of the invention relates to systems and methods for providing mystery awards to players playing wagering games.

2. Description of the Related Art

In casinos gaming devices, sometimes referred to as slot machines, include not only a base or primary games but one or more bonus games and/or special feature games. Typically the secondary (or featured) game(s) is/are triggered from an outcome obtained by the player in the base game. As but an example, a triggering symbol combination on a video reel base game may be designated such that, if the combination is obtained, entitles the player to play a feature or secondary game. The secondary game may be a series of free games or other feature. These bonus features are designed into the game and the award structure for the bonus or feature is accounted for when determining the theoretical payback percentage for the game, i.e. the theoretical payback to the player for each unit wagered. For example the base game may have a theoretical payback of 80% with the bonus feature having a theoretical payback (equivalent value based upon payback and bonus feature hit frequency) contributing another 15% yielding a game having an overall payback percentage of 95%. Bonus features such as sets of free games, or a “pick a prize” bonus or a spinning wheel game have equivalent values which contribute to the payback percentage for the game. Depending upon the base game payback, the hit frequency for the feature game, i.e. the probability that during any spin of the base game the feature game will be triggered, and the feature game payback the overall payback percentage for the game can be crafted as desired or required.

It also has been known to provide progressive awards in connection with the play of gaming terminals. The progressive prize structure may be set to apply to one or more banks of the gaming terminals though a local controller or local area network (LAN) or across several casino properties through a wide area network (WAN). An example of a LAN based progressive prize structure may be Tracy, U.S. Pat. No. 5,116,055 issued May 26, 1992 and titled “Progressive Jackpot Gaming System Linking Gaming machines With Different Hit Frequencies and Denominations”, the disclosure of which is incorporated by reference. An example of a WAN based progressive award is MEGABUCKS® (IGT) which provides like configured slot machines games in numerous venues with a defined top prize, symbol-based, award. Portions of the wagers on these games are aggregated into an award pool (and to seed the new start up pool value) and when any qualifying player (i.e. the player has made the required wager amount to qualify for the prize) on the network obtains the top prize symbol combination, the top prize is awarded. These progressive prizes can be in several millions of dollars. The probability for winning the top prize is based upon the probability for obtaining the winning combination which is determined by the number of virtual reel stops for the reels of the game, the number of reels and the distribution of the top prize awarding symbols on the reels. Telnaes, U.S. Pat. No. 4,448,419 issued May 15, 1984 and titled “Electronic Gaming Device Utilizing a Random Number Generator for Selecting the Reel Stop Positions” represents the shift from mechanical reels with reels stops to computer and video based games.

It has also been known to provide mystery bonus games which are not triggered from any base game outcome. These mystery awards can be provided on an individual machine basis but typically are provided over a bank of gaming terminals through a bank controller or on a system-wide basis through a system wide host server/controller arrangement. Examples of a bank delivered mystery bonuses are Torango, U.S. Pat. No. 6,592,460 issued Jul. 15, 2003 and titled “Progressive Wagering System” and Olive, U.S. Pat. No. 7,056,215 issued Jun. 6, 2006 and titled “Slot Machine Game and System with Improved Jackpot Feature”, the disclosures of which are hereby incorporated by reference. These patents disclose allocation of a percentage of a players' wagers to a pool and with every play conducting a draw of one or more numbers from a set of numbers and if a predetermined match occurs awarding the player a mystery prize. The prize may be randomly selected and thereafter issued through the play of a secondary game. Since the prize is awarded apart from the base game and is not related to a base game winning or losing outcome, it is referred to as a mystery prize. The number set from which one or more random numbers are drawn is selected such that, theoretically, the jackpot award should hit after a certain amount of money has been wagered. One drawback to these games is that, while the player can better their chances by increasing the wager placed on the base game, once they have reached the maximum base game wager, there is no mechanism by the player can increase their chances to win the mystery award.

An example of a system based mystery prize is found in Acres et al U.S. patent RE 38,812 re-issued Oct. 4, 2005 and titled “Method and Apparatus for Operating Networked Gaming Devices”, the disclosure of which is hereby incorporated by reference. According to this disclosure, a set of gaming terminals on the network are selected and a percentage of the wagers on the base games for the selected terminals are allocated to a network-wide bonus pool. When a predetermined criterion such as the pool reaching a certain amount is satisfied, an award is paid. This is often referred to in the gaming industry as a “coin-in mystery bonus” since the mystery award trigger is tied to the coin-in (wagers) at the gaming terminals.

A drawback of mysteries is that player cannot increase their chances of winning at their gaming terminal beyond waging a maximum bet.

Another drawback is that the players participating in the mystery are not often presented with an entertainment package in association with the mystery. Whether the mystery was triggered or not triggered is not presented to the players in a manner to provide entertainment value from winning and losing outcomes

In a broad aspect, there is a need for a mystery jackpot system and method which provides for player entertainment and excitement.

There is a need for a system and method where the player can increase their chances of winning the pool on any play beyond making a max bet on the underlying game.

The system-provided bonuses have heretofore been delivered by directly awarding cash or credits to the player at the gaming terminal or to the player's electronic account from which the player may download credits for play. Thus the bonus is delivered as cash or its equivalent. It would be advantageous if the system-provided bonus could be delivered through a feature, enhanced feature or additional feature. This would increase the entertainment value of the bonus. It would also be advantageous if different funds could be sourced for acquiring chances in the mystery game such as comps or points earned from food and beverage, lodging, gift shop, spa or golf purchases as well as funds donated from other sources.

In regards to casino play, and in the future it is anticipated Internet or mobile telephone or personal data assistant (PDA) wagering, operators drive player loyalty in one respect through system-provided bonusing. The casino (or gaming network) includes a communication network by which an operator can monitor player activity such as wagers, jackpots, games played and the like. Players are identified typically thought the player's use of a loyalty card having a machine readable stripe. For a brick and mortar casino an example of such a system is the Bally CMS® system sold by Bally Technologies, Inc. of Las Vegas, Nev. These systems interface with card readers at gaming terminals and table game input devices to provide the aforesaid tracking functions. Based upon the data collected the casino can provide bonuses to players in the way of benefits and incentives to retain a player's loyalty by, for example, awarding “comps” in the form of cash back, discounts for goods, lodging, services and gifts. The tracking can be restricted to a single enterprise venue or can be on a national basis such as described in Boushy, U.S. Pat. No. 7,419,427 issued Sep. 2, 2008 and titled “National Customer Recognition System and Method”, the disclosure of which is incorporated by reference. The level of “comps” available to the player is related to the player's rating which acts to quantify the value of the player to the casino. A higher rated player is one who spends and gambles more than a lower rated player. A higher rated player is entitled to more valuable or additional comps.

Bingo has long been a popular gaming activity. An example of an electronic bingo system is U.S. Pat. No. 7,481,707 issued Jan. 27, 2009 and entitled “Bingo Bonusing System and Method” the disclosure of which is incorporated by reference. In U.S. Pat. App. 2008/0139283 filed Jun. 12, 2008 and entitled “Player Gaming Console, Gaming Machine, Networked Gaming System and Method”, the disclosure of which is incorporated by reference, there is a disclosed a Bingo game offered through a system interface. In this disclosure, the player earns the right to play one or more Bingo cards based upon their level of play of the base game. Once one or more cards are enabled, software either resident on the gaming machine or server conducts a random draw and if there is a winning Bingo card(s) the player(s) is/are awarded the prize associated with the winning card(s).

In addition to the above it should be understood that for a casino enterprise increasing revenues is a major concern. Offering bonuses, including mystery bonuses, can increase revenue through greater gaming machine play. Further where players have to stake a wager to qualify for a progressive prize, additional revenues can be realized.

Another concern for a casino enterprise having a player loyalty program is the carried liability for awarded comps. If the program offers comp or player points in return for commercial activity engaged in by the customer at the enterprise such as gambling, dining, shopping or the like, and where the comp points can be redeemed for value such as cash, discounts or gifts, the enterprise must carry its exposure to player points. If a player is tourist, there may be long periods of time between visits and the player will expect their points to be retained. It would be beneficial if the enterprise offered a mechanism by which the liability for player points could be reduced by providing an incentive for players to retire/redeem such points in return for participation in a game provided at the participating casino or perhaps, in a legal format, through the Internet or mobile technology.

There is a need for a progressive game method and system which provides for a number of gaming machines from several to the entire casino floor of machines to participate ad contribute to the prize pool. There is a need for a progressive game method and system which provides for players to increase their chances to win the mystery even beyond making a maximum wager on their base game.

### SUMMARY OF THE INVENTION

There is provided according to embodiments of the present invention a system and method for providing a mystery driven game in an environment including a plurality of gaming terminals each one or more displays and configured for the play of one or more base games. The base game may be a video slot machine game, video Poker, Keno or other electronic video game or may be an electromechanical game having stepper motor driven reels, or a combination of the foregoing. The various embodiments of the present invention may be provided across gaming terminals of different manufacture, across a number of casino enterprises and can be applied in a downloadable or server-based gaming environment.

According to embodiment of the present invention a system for providing a mystery bonus award to a player is provided which includes a mystery bonus host computer and an associated data structure. The host computer is in communication with said gaming devices through a communication network. The mystery bonus computer may be an existing computer/server in a casino enterprise including a program module to provide the functionality of the one or more embodiments of the present invention, a separate computer/server within the casino enterprise venue(s) and linked to the network or a remote computer/server hosted by the third party linked to the network.

With any play on a participating gaming device the player receives at least one initial instance of a mystery game presentation such as a displayed Bingo card. The numbers on the Bingo card are preferably randomly assigned when the Bingo card is enabled; however player may be given the option of selecting their numbers or scrolling though Bingo cards to select the initial instance(s). A player input device disposed in association with the participating gaming terminals is in communication with said host computer over the network. The input device is configured to enable a player to establish one or more second instances of a mystery game presentation for display at the gaming device. Preferably the player must pay consideration to enable the second instances such as wagering credits inventoried at their gaming device, redeeming a voucher, coupon or comp points, earning one or more second instances within or outside of the enterprise through some designated activity, paying from an electronic account or depositing money.

The host computer is configured to receive a signal in response to base game play prompts from each gaming device and in response to receipt of said signal determine if a mystery award trigger condition has been satisfied. In one embodiment a total mystery game play number Z is selected as a mystery trigger. This number can be based upon the odds of a certain outcome occurring in the game “instance-type” such as the first four draws in Bingo matching the four corners of a Bingo card, odds in a slot machine mystery game instance-type, sporting event or the like. By “instance-type” what is meant is the nature of the mystery game presentation game or event. For example, where the game instance-type is Bingo, mathematical odds are associated with certain outcomes such as the first four Bingo balls drawn matching the four corner spots on a Bingo card. With each base game play prompt the host computer is configured to determine the number of enabled mystery game presentation(s) associated with the gaming device. As the gaming devices are played the aggregate number of mystery plays increases toward Z. When the trigger condition has been satisfied, e.g. the total number of mystery game instances played, a trigger condition is satisfied and the host computer determines a winning gaming device. The winning gaming device may be the device associated with the enabled mystery game instance which caused the aggregate to reach/exceed Z or it may be another selected gaming device. Once the award has been triggered an award is allocated to a winning gaming device and the display at the winning gaming device is controlled to display a winning outcome video sequence for at least one game instance. For example where the mystery game is a Bingo card presentation, the display is controlled to show a winning Bingo outcome. Where the trigger condition has not been satisfied the displays are controlled to display losing outcome video sequences for each instance of said mystery game presentation.

A feature of the present invention is that the players can increase their chances of winning by enabling more mystery game instances at their gaming device. In one embodiment the players may enable mystery game instances in groups or lots, e.g. enable a group of four more instances.

A feature of the present invention is that the players can retire casino comp points to provide the enabling consideration. This provides a benefit to the casino of diminishing their ongoing comp point liability. The casino may also offer coupons, vouchers or other promotions which the players can use as consideration. The casino may be able to offer promotions where players earn additional mystery game instances through certain activities such as visiting the casino website or social media site, for voting to “like” the casino enterprise on a social media site, for booking hotel rooms, dining or engaging in surveys or playing promotional games.

In an embodiment, a progressive pool may be aggregated from the enabled game instances. As an example, players may get an enterprise bought “free” mystery game instance with their base game wager, i.e. a free entry. A percentage of their base game wager may be taken to fund the pool. When players purchase additional, secondary instances at least a portion is used to also fund the pool.

Various mystery award triggers may be used. For example, as described above, an aggregate number Z of enabled game instances may be used as a trigger. Where a progressive pool is created a predetermined or randomly set pool accumulation value may be used as the trigger, i.e. when the pool reached $20,000. Another trigger may be by a virtual lottery. Gaming Class II and virtual lottery techniques may also be used to trigger the mystery awards.

In an embodiment a local controller may be provided in association with one or participating gaming terminals. The local controller is configured to store data for controlling the display of the mystery game presentations to display one or more winning and losing outcome presentations. These presentations may be stored locally as graphics files. Where the host determines that an award should issue, it sends a signal to the local controller which controls the display to present a winning mystery game outcome presentation. For example, where the mystery game presentation is a Bingo game the controller may control the display to depict a Bingo card matching four corners within the first four Bingo balls drawn when the corresponding trigger condition is satisfied. Otherwise the local controller is controlled to select and present a losing outcome presentation.

The one or more mystery game presentations may be, for example, Bingo cards, slot game displays, Keno cards, sports related offerings such as baseball where a winning outcome is shown as a home run and a losing outcome as a swing and a miss at a pitch, horserace where instances are different horses, golf where instances are shots at a hole-in-one and a winning outcome is presented as making a hole-in-one, archery or shooting games where instances are shots at a target or other games perhaps consistent with a theme of a local, national or international event or of the casino enterprise.

More than one mystery prize may be awarded. For example the host computer may be configured to provide a primary prize and a secondary prize.

Other features and numerous advantages of the various embodiments will become apparent from the following detailed description when viewed in conjunction with the corresponding drawings.

### BRIEF DESCRIPTION OF THE DRAWINGS

FIG. 1 illustrates a gaming terminal;

FIGS. 2A-B illustrate an example of a gaming terminal operational platform and components for a gaming terminal of the type of the present invention;

FIG. 3 is a block diagram of the logical components of a gaming kernel for a gaming terminal.

FIGS. 4A and 4B is a schematic of an example of a casino enterprise network incorporating gaming terminals;

FIG. 5 is a diagram showing an example of an architecture for tying a casino enterprise network to an external provider of games and content to Internet or broadband communication capable devices;

FIG. 6 is a schematic showing incorporation of a Mystery Bingo Service according to one embodiment of the present invention;

FIGS. 7A and 7B illustrate several tracking module displays according to an embodiment of the present invention;

FIG. 8 shows a player tracking module display during the play of a game according to the present invention;

FIG. 9 is a logic diagram for operation of an embodiment of the invention;

FIG. 10 illustrates the play of a slot machine game instance according to an embodiment of the present invention;

FIG. 11 is a table showing an example of the funding of mystery jackpot pools for Level 1 and Level 2 awards for the base game wager funded mystery game instance;

FIG. 12 is a table showing an example of additional mystery game participation instances which can be purchased by a player; and

FIG. 13 is a table showing progressive prize proration based upon the player's base game wager funded mystery game instance.

### DETAILED DESCRIPTION OF THE PREFERRED EMBODIMENTS

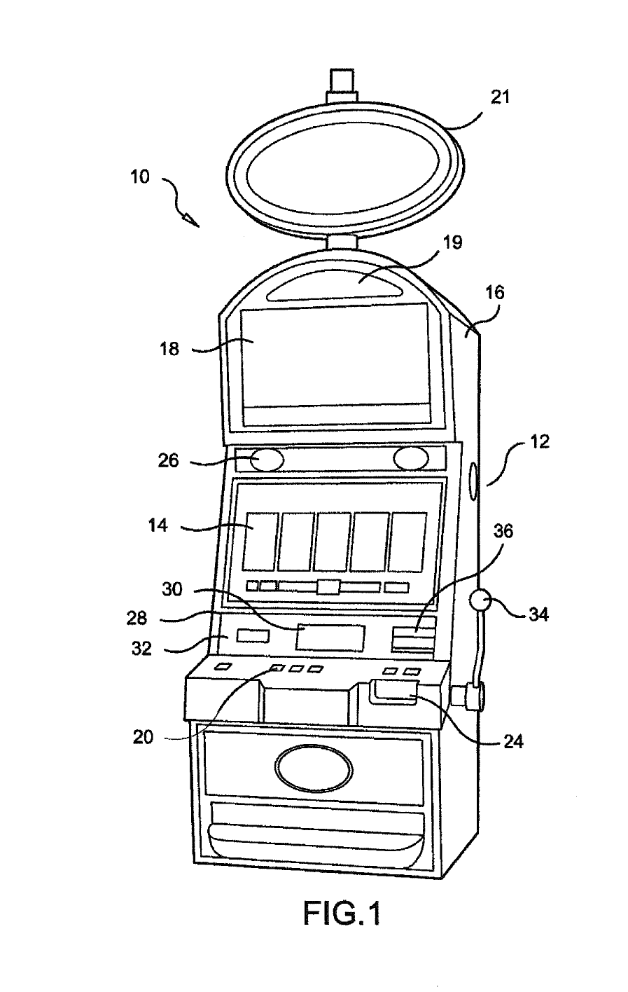

Referring now to the drawings, wherein like reference numbers denote like or corresponding elements throughout the drawings, and more particularly referring to FIG. 1, a gaming device 10 according to one or more embodiments of the present invention is shown. The gaming device 10 includes cabinet 12 providing an enclosure for the several components of the gaming device 10 and associated equipment. A primary game display 14 is mounted to the cabinet 12. The primary game display 14 may be a video display such as an LCD, plasma, OLED or other electronic display or it may be an electro-mechanical display such as electro-mechanical stepper reels as are known in the art. The primary game display 14 may also be embodied as a combination of two or more electronic or mechanical displays disposed in an adjacent overlapping or overlying arrangement. The primary game display 14 may be mounted to one or more of a door for the cabinet 12 or the cabinet chassis itself. The primary game display 14 is located to display game content (and if desired other content) to the player. For example, the game content may be game outcomes presented by a plurality of video or electro-mechanical reels displaying symbols the combinations of which define winning or losing outcomes, video Poker, Keno or other form of base casino wagering game as is known in the art. Where the primary game display 14 is a video display, features such as bonus/feature games may also be presented. The foregoing description should not be deemed as limiting the content (graphics, video or text) which can be displayed at the primary game display 14. The cabinet 12 may comprise a slant-top, bar-top, or table-top style cabinet as is known in the art.

The gaming device 10 also includes in one or more embodiments a top box 16 which may support a printed back-lit glass (not shown) as is known in the art depicting the rules, award schedule, attract graphics or it may support a secondary game display 18 which may be of one of the types described above with reference to the primary game display 14. The top box 16 may also support a backlit glass with graphics defining a marquee 19 and a topper 21 including additional graphics.

To enable a player to provide input to the controller for the gaming device 10 a plurality of buttons 20 may be provided on a button deck for the gaming device 10. Additionally and alternatively one or both of the primary and secondary game displays 14, 18 may include touch screen input devices as are known in the art. Buttons, selections or inputs are displayed at the primary and secondary game displays 14, 18 and the player touching those icons or designated areas provides the required or desired input to configure and play the gaming device 10.

Other peripherals or associated equipment for the gaming device 10 include a bill/voucher acceptor 24 which reads and validates currency and vouchers for the player to establish credits for gaming on the gaming device 10 and one or more speakers 26 to provide audio to the player in association with the game play. To provide for communication between the gaming device 10 and a casino system, a player tracking module (PTM) 28 is mounted on the cabinet 12. PTM 28 has a PTM display 30 to display system related information to the player. The PTM display 30 may be a small LCD, plasma or OLED display with touch screen functionality. The mystery bonus game presentation(s) are displayed at the PTM display 30; however, as set forth below these presentations can be migrated to the primary or secondary displays 14, 18. A card reader 32 is provided to read a machine readable component on a player loyalty card issued to the player to identify the player to the casino system as in known in the art. A ticket printer 36 may be provided as well on the PTM 28 or elsewhere on the gaming device 10 to provide printed value ticket vouchers to players as is known in the art.

Some functionality of the PTM 28 may be provided by a video switcher and touch router device as is described in U.S. Pub. App. 2009/0149253 entitled “Video Switcher and Touch Router Method for a Gaming Machine” filed Jan. 8, 2009 and incorporated by reference. According to this disclosure system and externally based content including the mystery game presentations as hereinafter described may be displayed at one or more of the primary or secondary displays 14, 18 dispensing with the need for the PTM display 30.

While the player may use the buttons 20 to prompt play of the game (or the touch screen input), alternatively the player may use a handle 34 to prompt an input as is known in the art.

Cabinet 12 may be a self-standing unit that is generally rectangular in shape and may be manufactured with reinforced steel or other rigid materials which are resistant to tampering and vandalism. Any shaped cabinet may be implemented with any embodiment of gaming machine 10 so long as it provides access to a player for playing a game. For example, cabinet 12 may comprise a slant-top, bar-top, or table-top style cabinet, including a Bally Cinevision™ or CineReels™ cabinet. The gaming device 10 may include a controller and memory disposed within the cabinet 12 or may have thin client capability such as that some of the computing capability is maintained at a remote server.

The plurality of player-activated buttons 20 may be used for various functions such as, but not limited to, selecting a wager denomination, selecting a game to be played, selecting a wager amount per game, initiating a game, or cashing out money from gaming machine 10. Buttons 20 may be operable as input mechanisms and may include mechanical buttons, electromechanical buttons or touch screen buttons. In one or more embodiments, buttons 20 may be replaced with various other input mechanisms known in the art such as, but not limited to, touch screens, touch pad, track ball, mouse, switches, toggle switches, or other input means used to accept player input. For example, one input means is as disclosed in U.S. Pub. App. 2011/0111853, entitled “Universal Button Module,” filed on Jan. 14, 2011 and/or U.S. Pub. App. 2010/0113140 entitled “Gesture Enhanced Input Device” filed Nov. 16, 2009 which are hereby incorporated by reference. Player input may also be by providing touch screen functionality at the primary game display 14 and/or secondary display 18.

The primary game display 14 may present a base game of chance wherein a player receives one or more outcomes from a set of potential outcomes. For example, one such game of chance is a video slot machine game. In other aspects of the invention, gaming machine 10 may present a video or mechanical reel slot machine, a video keno game, a lottery game, a bingo game, a Class II bingo game, a roulette game, a craps game, a blackjack game, a mechanical or video representation of a wheel game or the like.

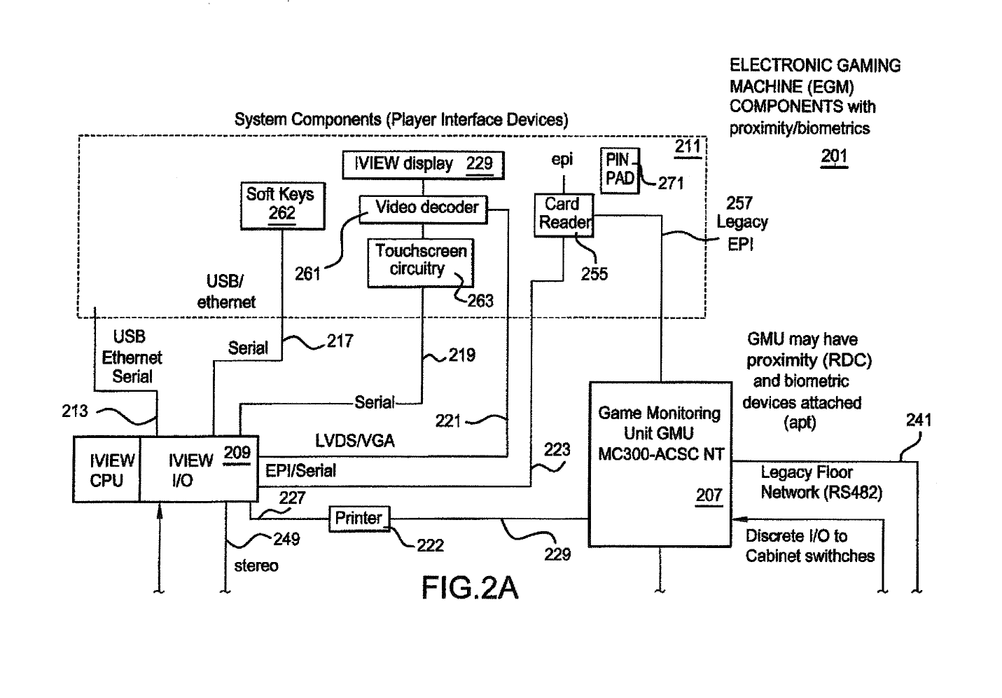

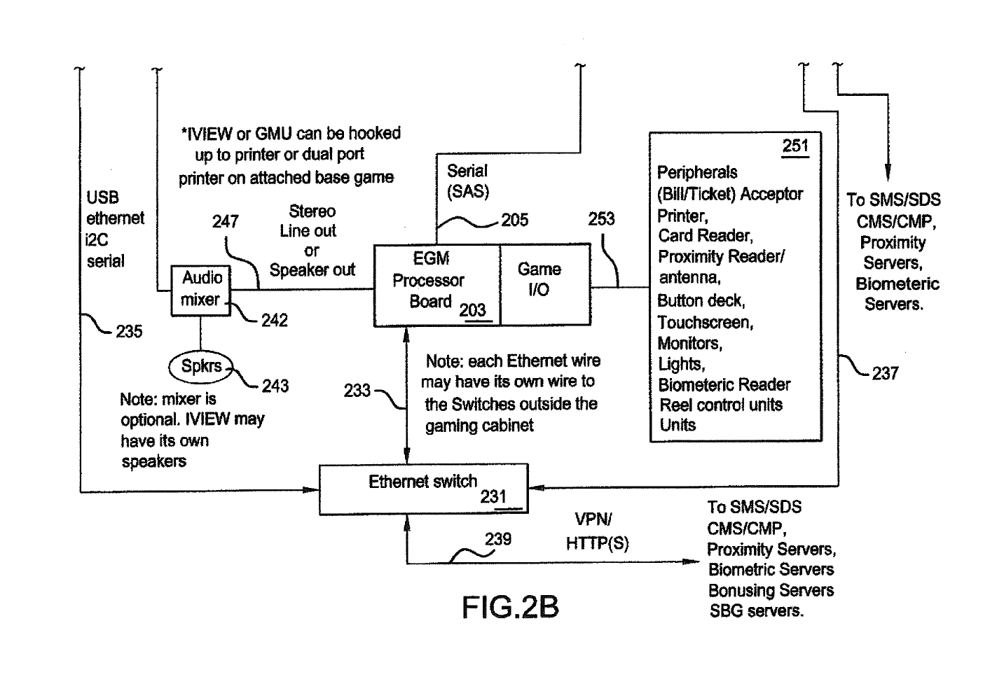

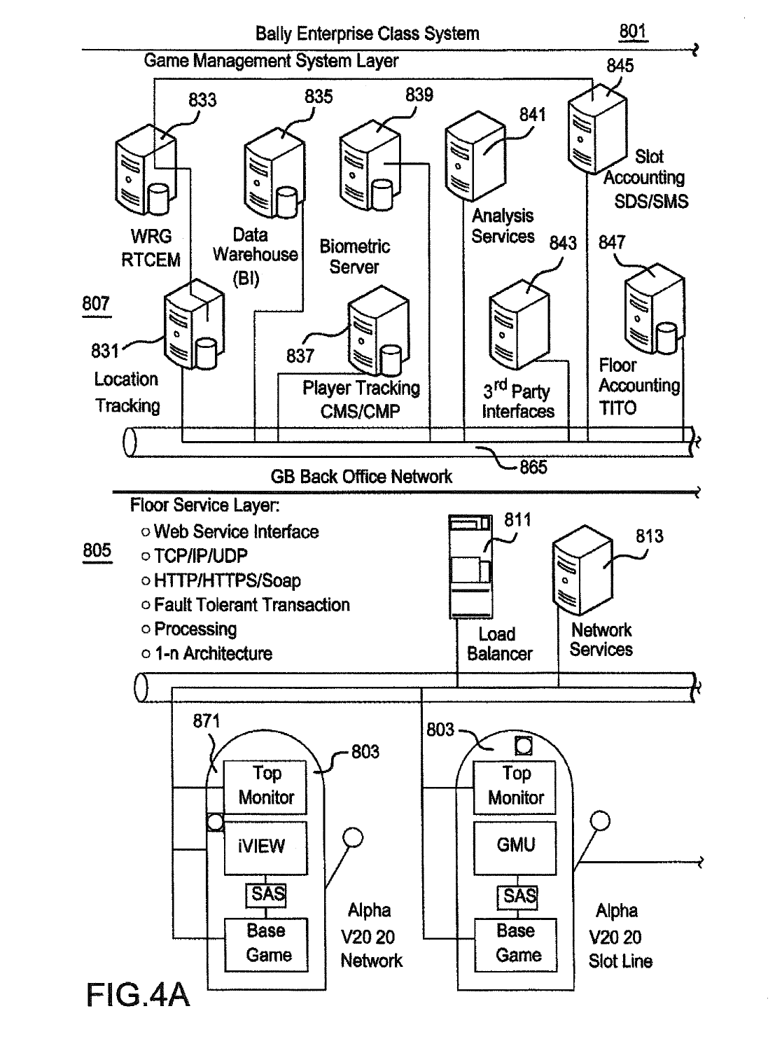

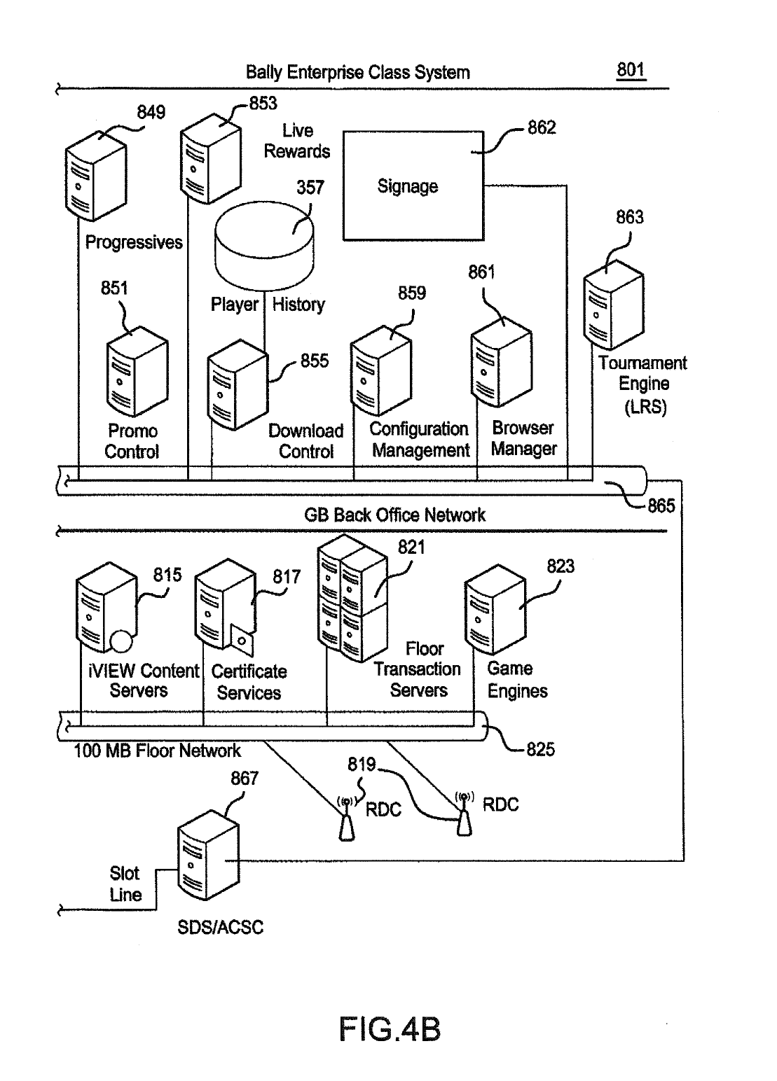

Referring to FIGS. 2A, B, the gaming device 10 hardware 201 for the controller(s) is shown in accordance with one or more embodiments. The hardware 201 includes base game processor board 203 (EGM Processor Board) connected through serial bus line 205 to game monitoring unit (GMU) 207 (such as a Bally MC300 or ACSC NT manufactured and sold by Bally Gaming, Inc., Las Vegas, Nev.). EGM Processor Board 203 is connected to the PID 209 over bus line 249 and PID 209 is connected to the iView device such as 211 in FIG. 2A through bus lines 213, 217, 219, 221, 223. The PID 209 provides for communication between one or more gaming devices 10 and the casino system such as the type as hereinafter described. Inasmuch as gaming devices 10 may be manufactured by different entities, mounting like PTMs 28, 211 and PIDs 209 at each gaming device 10 provides for communication to the system in one or more common message protocols. Typically when a casino enterprise purchases a casino management system they also purchase the same manufacturer's PTMs 28, 211 and PIDs 209 which are then installed by the various manufacturers of the gaming devices 10 for the enterprise before delivery. In this manner the mountings for the PTMs 28, 211 on the gaming devices can be configured for location and esthetic appearance. Gaming voucher ticket printer 36 (for printing player cash out tickets) (shown as 222 in FIG. 2A) is connected to PID 209 and GMU 207 over bus lines 227, 229. EGM Processor Board 203, PID 209 and GMU 207 connect to Ethernet switch 231 over bus lines 233, 235, 237. Ethernet switch 231 connects to a slot management system and a casino management system (SMS, SDS, CMS and CMP) (FIGS. 4A, 4B) network over bus line 239. Ethernet switch 231 may also connect to a server based gaming server or a downloadable gaming server. GMU 207 also may connect to the network over bus line 241. Speakers 26 (shown as 243 in FIG. 2B) to produce sounds related to the game or according to the present invention connect through audio mixer 242 and bus lines 247, 249 to EGM Processor Board 203 and PID 209.

Peripherals 251 connect through bus 253 to EGM Processor Board 203. The peripherals 251 include, but are not limited to the following and may include individual processing capability: bill/voucher acceptor 24 to validate and accept currency and ticket vouchers, the player interfaces such a buttons 20, primary and secondary game displays 14, 18 and any secondary or tertiary displays (with/without) touch screen functionality, monitors and lights. The peripherals 251 may include the displays as hereinafter described with reference to the various embodiments of the present invention as herein described or their equivalents. For example, the bill/voucher acceptor 24 is typically connected to the game input-output board of the EGM processing board 203 (which is, in turn, connected to a conventional central processing unit (“CPU”) board), such as an Intel Pentium® microprocessor mounted on a gaming motherboard. The I/O board may be connected to CPU processor board 203 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. EGM processor board 203 executes a game program that causes the gaming device 10 to display and play a game. The various components and included devices may be installed with conventionally and/or commercially available components, devices, and circuitry into a conventional and/or commercially available gaming terminal cabinet 12.

When a player has inserted a form of currency such as, for example and without limitation, paper currency, coins or tokens, cashless tickets or vouchers, electronic funds transfers or the like into the currency acceptor, a signal is sent by way of bus 253 to the I/O board and to EGM processor board 203 which, in turn, assigns an appropriate number of credits for play in accordance with the game program. The player may further control the operation of the gaming machine by way of other peripherals 251, for example, to select the amount to wager via the buttons 20. The game starts in response to the player operating a start mechanism such as the handle 34, button 20 such as a SPIN/RESET button or a touch screen icon. The game program includes a random number generator to provide a display of randomly selected indicia on one or more displays such as the primary game display 14 as shown in FIG. 1. In some embodiments, the random generator may be physically separate from gaming device 10; for example, it may be part of a central determination host system which provides random game outcomes to the game program. Finally, EGM processor board 203 under control of the game program and OS compares the outcome to an award schedule. The set of possible game outcomes may include a subset of outcomes related to the triggering and play of a feature or bonus game. In the event the displayed outcome is a member of this subset, EGM processor board 203, under control of the game program and by way of I/O Board, may cause feature/bonus game play to be presented on the primary game display 14 and/or any secondary display(s) 18.

Predetermined payout amounts for certain outcomes, including feature game outcomes, are stored as part of the game program. Such payout amounts are, in response to instructions from EGM processor board 203, provided to the player in the form of coins, credits or currency via I/O board and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In an embodiment, the remote storage device is housed in a remote server such as a downloadable gaming server. The gaming machine may access the remote storage device via a network connection, including but not limited to, a local area network connection, a TCP/IP connection, a wireless connection, or any other means for operatively networking components together. Optionally, other data including graphics, sound files and other media data for use with the gaming terminal are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the gaming terminal using USB, serial or Ethernet connections. Each of the respective devices may have upgrades to their firmware utilizing these connections.

GMU 207 includes an integrated circuit board and GMU processor and memory including coding for network communications, such as the G2S (game-to-system) protocol from the Gaming Standards Association, Las Vegas, Nev., used for system communications over the network. As shown, GMU 207 may connect to the card reader 32 (shown as 255 in FIG. 2A) through bus 257 and may thereby obtain player information and transmit the information over the network through bus 241. Gaming activity information may be transferred by the EGM Processor Board 203 to GMU 207 where the information may be translated into a network protocol, such as S2S, for transmission to a server, such as a player tracking server, where information about a player's playing activity may be stored in a designated server database.

PID 209 includes an integrated circuit board, PID processor (iView CPU), and memory which includes an operating system, such as Windows CE, a player interface program which may be executable by the PID 209 processor together with various input/output (I/O) drivers for respective devices which connect to PID processor and which may further include various games or game components playable on PTM 28, 211 or playable on a connected network server and PTM 28, 211 is operable as the player interface. PID 209 connects to card reader 32 (shown as 255 in FIG. 2A) through bus 223, player tracking display 30 (shown as iView display 229 in FIG. 2A) through video decoder 261 and bus 221, such as an LVDS or VGA bus.

As part of its programming, the PID 209 processor executes coding to drive player tracking display 30, 229 and provide messages and information to a player. Touch screen circuitry 263 interactively connects PTM display 30, 229 and video decoder 261 to PTM 28, 211 such that a player may input information and causes the information to be transmitted either on the player's initiative or responsive to a query. Additionally soft keys 262 connect through bus 217 to PID 209 and operate together with the player tracking display 30 to provide information or queries to a player and receive responses or queries from the player. PID 209, in turn, communicates over the CMS/SMS network through Ethernet switch 231 and busses 235, 239 and with respective servers, such as a player tracking server.

PTMs 28 are linked into the virtual private network of the system components in gaming terminal 10. The system components include the player tacking module 28 (e.g. Bally iVIEW® device) (‘iView” is a registered trademark of Bally Gaming, Inc.), PID 209, EGM processing board 203 and game monitoring unit (GMU) processing board 207. These system components may connect over a network to the slot management system (such as a commercially available Bally SDS/SMS) and/or casino management system (such as a commercially available Bally CMP/CMS).

The GMU 207 system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to installation on the system components.

The system components include the PTM 28 processing board (PID 209) and game monitoring unit (GMU) 207. The GMU 207, PID 209 and PTM 28 can be combined into one like the commercially available Bally GTM iVIEW device. This device may have a video mixing technology to mix the EGM processor's video signals with the iVIEW display onto the top box monitor or any monitor on the gaming device.

The PTM 28 may also interface with a switcher and router device of the type described above. In such case, instead of providing the PTM display 30, the switcher and router device provides for the content normally display at the PTM display 30 to be displayed at one or more of the primary or secondary displays 14, 18.

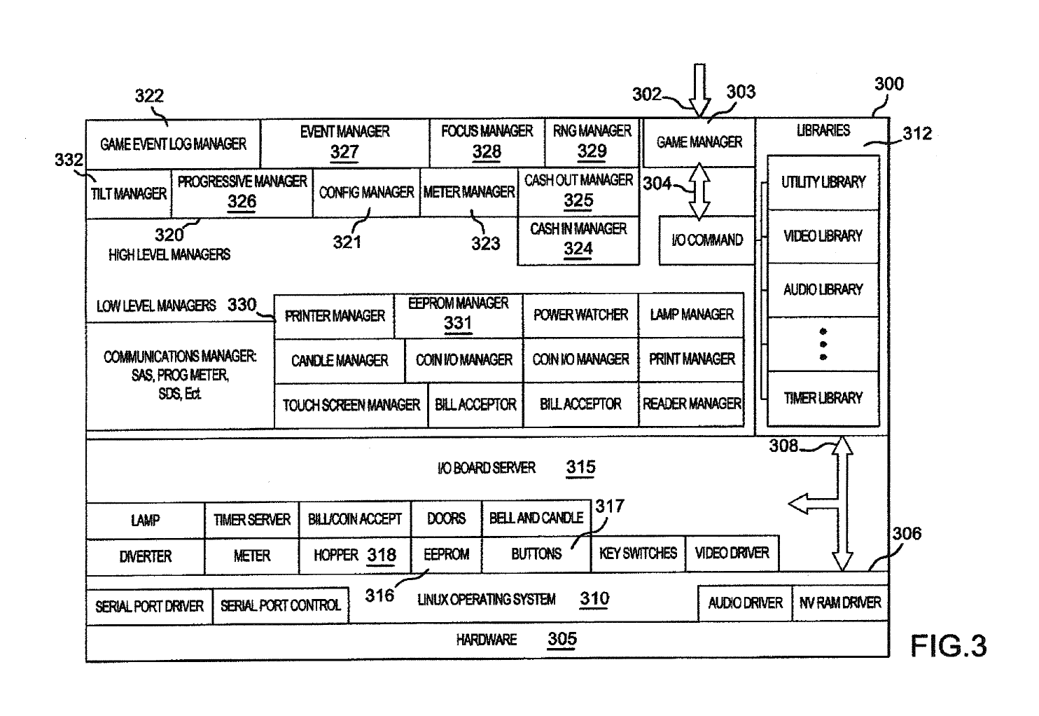

In accordance with one or more embodiments, FIG. 3 is a functional block diagram of a gaming kernel 300 of a game program under control of gaming device EGM processor board 203. The game program uses gaming kernel 300 by calling into application programming interface (API) 302, which is part of game manager 304. The components of game kernel 300 as shown in FIG. 3 are only illustrative, and should not be considered limiting. For example, the number of managers may be changed, additional managers may be added or some managers may be removed without deviating from the scope and spirit of the invention.

As shown in the example, there are three layers: a hardware layer 306; an operating system layer 308, such as, but not limited to, Linux; and a game kernel layer having game manager 304 therein. In one or more embodiments, the use of an operating system layer 310, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel 300 executes at the user level of the operating system layer 308, and itself contains a major component called the I/O board server 315. To properly set the bounds of game application software (making integrity checking easier), all game applications interact with gaming kernel 300 using a single API 302 in game manager 304. This enables game applications to make use of a well-defined, consistent interface, as well as making access points to gaming kernel 300 controlled, where overall access is controlled using separate processes.

For example, game manager 304 parses an incoming command stream and, when a command dealing with I/O comes in (arrow 312), the command is sent to an applicable library routine 314. Library routine 314 decides what it needs from a device, and sends commands to I/O board server 310 (see arrow 308). A few specific drivers remain in operating system layer 310's kernel, shown as those below line 306. These are built-in, primitive, or privileged drivers that are (i) general (ii) kept to a minimum and (iii) are easier to leave than extract. In such cases, the low-level communications is handled within operating system layer 310 and the contents passed to library routines 314.

Thus, in a few cases library routines may interact with drivers inside operating system layer 310, which is why arrow 308 is shown as having three directions (between library routines 314 and I/O board server 315, or between library routines 314 and certain drivers in operating system layer 306). No matter which path is taken, the logic needed to work with each device is coded into modules in the user layer of the diagram. Operating board server layer 306 is kept as simple, stripped down, and common across as many hardware platforms as possible. The library utilities and user-level drivers change as dictated by the game cabinet or game machine in which it will run. Thus, each game cabinet or game machine may have an industry standard EGM EGM processing board 203 connected to a unique, relatively dumb, and as inexpensive as possible I/O adapter board, plus a gaming kernel 300 which will have the game-machine-unique library routines and I/O board server 315 components needed to enable game applications to interact with the gaming machine cabinet. Note that these differences are invisible to the game application software with the exception of certain functional differences (i.e., if a gaming cabinet has stereo sound, the game application will be able make use of API 302 to use the capability over that of a cabinet having traditional monaural sound).

Game manager 304 provides an interface into game kernel 300, providing consistent, predictable, and backwards compatible calling methods, syntax, and capabilities by way of game application API 302. This enables the game developer to be free of dealing directly with the hardware, including the freedom to not have to deal with low-level drivers as well as the freedom to not have to program lower level managers 330, although lower level managers 330 may be accessible through game manager 304's interface if a programmer has the need. In addition to the freedom derived from not having to deal with the hardware level drivers and the freedom of having consistent, callable, object-oriented interfaces to software managers of those components (drivers), game manager 304 provides access to a set of high level managers 320 also having the advantages of consistent callable, object-oriented interfaces, and further providing the types and kinds of base functionality required in casino-type games. Game manager 304, providing all the advantages of its consistent and richly functional game application API 302 as supported by the rest of game kernel 300, thus provides a game developer with a multitude of advantages.

Game manager 304 may have several objects within itself, including an initialization object (not shown). The initialization object performs the initialization of the entire game machine, including other objects, after game manager 304 has started its internal objects and servers in appropriate order. In order to carry out this function, the kernel's configuration manager 321 is among the first objects to be started; configuration manager 321 has data needed to initialize and correctly configure other objects or servers.

The high level managers 320 of game kernel 300 may include game event log manager 322 which provides, at the least, a logging or logger base class, enabling other logging objects to be derived from this base object. The logger object is a generic logger; that is, it is not aware of the contents of logged messages and events. The game event log manager's 322 job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 323 manages the various meters embodied in the game kernel 300. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 323 receives its initialization data for the meters, during start-up, from configuration manager 321. While running, the cash in manager 324 and cash out manager 325 call the meter manager's 323 update functions to update the meters. Meter manager 323 will, on occasion, create backup copies of the soft meters by storing the soft meters' readings in EEPROM. This is accomplished by calling and using EEPROM manager 331.

In accordance with still other embodiments, progressive manager 336 manages progressive games playable from the game machine. Event manager 327 is generic, like game event log manager 327, and is used to manage various gaming machine events. Focus manager 328 correlates which process has control of various focus items. Tilt manager 332 is an object that receives a list of errors (if any) from configuration manager 321 at initialization, and during game play from processes, managers, drivers, etc. that may generate errors. Random number generator manager 329 is provided to allow easy programming access to a random number generator (RNG), as a RNG is required in virtually all casino-style (gambling) games. Random number generator manager 329 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 325 has the responsibility of configuring and managing monetary output devices. During initialization, cash out manager 325, using data from configuration manager 321, sets the cash out devices correctly and selects any selectable cash out denominations. During play, a game application may post a cash out event through the event manager 327 (the same way all events are handled), and using a call back posted by cash out manager 325, cash out manager 325 is informed of the event. Cash out manager 325 updates the credit object, updates its state in non-volatile memory, and sends an appropriate control message to the device manager that corresponds to the dispensing device. As the device dispenses dispensable media, there will typically be event messages being sent back and forth between the device and cash out manager 325 until the dispensing finishes, after which cash out manager 325, having updated the credit manager and any other game state (such as some associated with meter manager 323) that needs to be updated for this set of actions, sends a cash out completion event to event manager 327 and to the game application thereby. Cash in manager 324 functions similarly to cash out manager 325, only controlling, interfacing with, and taking care of actions associated with cashing in events, cash in devices, and associated meters and crediting.

In a further example, in accordance with one or more embodiments, I/O board server 315 may write data to the gaming machine EEPROM memory, which is located in the gaming machine cabinet and holds meter storage that must be kept even in the event of power failure. Game manager 304 calls the I/O library functions to write data to the EEPROM. The I/O board server 315 receives the request and starts a low priority EEPROM manager 331 thread within I/O board server 315 to write the data. This thread uses a sequence of 8 bit command and data writes to the EEPROM device to write the appropriate data in the proper location within the device. Any errors detected will be sent as IPC messages to game manager 304. All of this processing is asynchronous.

In accordance with one embodiment, button module 317 within I/O board server 315, polls (or is sent) the state of buttons every 2 ms. These inputs are debounced by keeping a history of input samples. Certain sequences of samples are required to detect a button was pressed, in which case the I/O board server 315 sends an inter-process communication event to game manager 304 that a button was pressed or released. In some embodiments, the gaming machine may have intelligent distributed I/O which debounces the buttons, in which case button module 317 may be able to communicate with the remote intelligent button processor to get the button events and simply relay them to game manager 304 via IPC messages. In still another embodiment, the I/O library may be used for pay out requests from the game application. For example, hopper module 318 must start the hopper motor, constantly monitor the coin sensing lines of the hopper, debounce them, and send an IPC message to the game manager 304 when each coin is paid.

Further details, including disclosure of lower level fault handling and/or processing, are included in U.S. Pat. No. 7,351,151 issued Apr. 1, 2008 entitled “Gaming Board Set and Gaming Kernel for Game Cabinets” the disclosure of which is incorporated herein by explicit reference.

Referring to FIGS. 4A and B, an example of a gaming enterprise system 801 is shown in accordance with one or more embodiments. Gaming enterprise system 801 may include one casino or multiple locations (herein referred to collectively as a casino enterprise) and generally includes a network of gaming terminals 803 (including gaming devices 10 of the type as described in FIG. 1), floor management system (SMS) 805, and casino management system (CMS) 807. SMS 805 may include load balancer 811, network services server 813, player tracking module 28, iView (PTM 28), content servers 815, certificate services server 817, floor radio dispatch receiver/transmitters (RDC) 819, floor transaction servers 821 and game engines 823 (where the gaming terminals 803 operate server based, server supported or downloadable games), each of which may connect over network bus 825 to gaming terminals 803. CMS 807 may include location tracking server 831, WRG RTCEM (William Ryan Group Real Time Customer Experience Management from William Ryan Group, Inc. of Sea Girt, N.J.) server 833, data warehouse server 835, player tracking server 837, biometric server 839, analysis services server 841, third party interface server 843, slot accounting server 845, floor accounting server 847, progressives server 849, promo control server 851, bonus game (such as Bally Live Rewards) server 853, download control server 855, player history database 857, configuration management server 859, browser manager 861, tournament engine server 863 connecting through bus 865 to server host 867 and gaming terminals 803. The various servers and gaming terminals 803 may connect to the network with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming terminals 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

The gaming terminals 803 include various peripheral components that may be connected with USB, serial, parallel, RS-485 or Ethernet devices/architectures to the system components within the respective gaming machine. The GMU (shown as GMU 206 in FIG. 2A) has a connection to the base game through a serial SAS connection. The system components in the gaming cabinet may be connected to the servers using HTTPs or G2S protocols over Ethernet. Using CMS 807 and/or SMS 805 servers and devices, firmware, media, operating systems, and configurations may be downloaded to the system components of respective gaming devices for upgrading or managing floor content and offerings in accordance with operator selections or automatically depending upon CMS 807 and SMS 805 master programming. The data and programming updates to gaming terminals 803 are authenticated using conventional techniques prior to install on the system components.

In various embodiments, any of the gaming devices 803 may be a mechanical reel spinning slot machine, video slot machine, video poker machine, video Bingo machine, Keno machine, or a gaming device offering one or more of the above described games including an interactive wheel feature. Alternately, gaming devices 803 may provide a game with an accumulation-style feature game as one of a set of multiple primary games selected for play by a random number generator, as described above. A gaming system 801 of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in Vallejo et al U.S. Published Application 2008/0139305, entitled “Networked System and Method for Group Gaming,” filed on Nov. 9, 2007, which is hereby incorporated by reference in its entirety for all purposes.

The gaming system 801, among other functionalities such as slot accounting (i.e. monitoring the amount wagered (“drop”), awards paid) and other casino services, includes the player tracking CMS/CMP server 837 and/or data warehouse 835 storing player account data. This data includes personal data for players enrolled in the casino players club sometimes referred to as a loyalty club. An example of the personal data is the player's name, address, SSN, birth date, spouse's name and perhaps personal preferences such as types of games, preferences regarding promotions, player rating level, available player comp points (points accumulated based upon commercial “spend” activity with the enterprise including gaming and which may be redeemed or converted into cash or merchandise) and the like. As is known in the industry and according to the prior art, at enrolment the player is assigned a created account in the player tracking CMS/CMP server 837 and is issued a player tracking card having a machine readable magnetic stripe.

It should be noted in connection to the above that the casino enterprise retains (virtually) the comp points in the players accounts. These comp points may be considered a liability inasmuch as some time in the future the player may seek to redeem or convert those points. Often such points may be redeemed/converted by a player proactively requesting the cash value or though redemption and retirement of points used to pay for things such as meals, shows, merchandise or lodging. It would be advantageous if an additional means were provided to an enterprise to incentivize redemption and retirement of player comp points to decrease any comp point related carried liability.

When a player plays a gaming device 10 (or terminal 803) (hereinafter collectively referred to as gaming devices 10), he/she inserts their player tracking card into the card reader 32 (FIG. 1) which communicates data to the CMS/CMP server 837 to accumulate loyalty (“comp”) points based upon the wagers/wins of the player. For example, a player may accumulate one comp point for each $5 wagered. Comp points may also be awarded as part of a promotion and for other commercial activity such as the purchase of goods or services.

The system 801 may also include electronic transfer of funds functionality. For example, a player having accumulated $100 at a gaming terminal 10 may decide to “cash out” to play another gaming terminal 10. The player, for example using the PTM 28 to initiate communication with the system 801 for example server 837 to upload the value from the gaming terminal 10 into an electronic account associated with the player's account. The player may choose to upload all or a portion of the funds the player's established electronic account. The system would prompt the player to enter their PIN (or obtain biometrical confirmation as to the player's identity) and upload the chosen amount to their account. When the player moves to another gaming terminal 10 he/she inserts their player loyalty card into the card reader 32 to access their account. A prompt provides for the player to request funds from their account. Entering their PIN (or biometric identifier) the player can input the desired amount which is downloaded to their gaming terminal 10 for play.

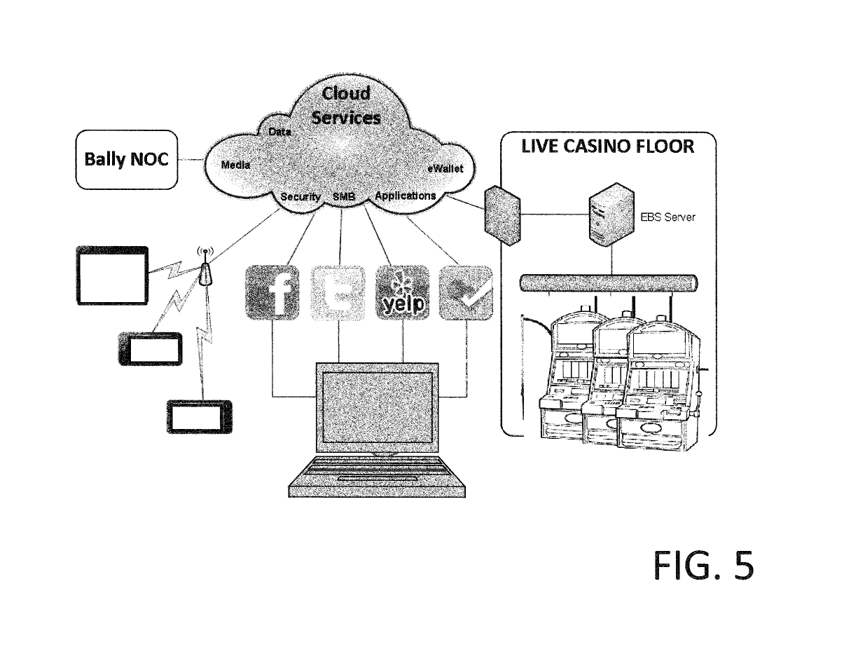

All or portions of the present invention may be implemented or promoted by or through a system as suggested in FIG. 5. At 501 is the gaming enterprise system which may be hosted at a casino property enterprise, across several casino enterprises or by a third party host. As described above the gaming enterprise system 501 has a network communication bus 865 providing for communication between the gaming devices 10 and various servers as described above with respect to FIGS. 4A,B. To provide the functionality illustrated in FIG. 5, a feature server 500, such as a Bally Elite Bonusing Server, is connected to the network communication bus 865 for communication to the gaming system 801, the gaming devices 10 and the various servers and other devices as described above. Through a secure network firewall 502 the feature server 500 is in communication with a cloud computing/storage service 514 which may be hosted by the casino enterprise, a licensed third party or if permitted by gaming regulators an unlicensed provider. For example the cloud service 514 may be as provided by Microsoft® Private Cloud Solutions offered by Microsoft Corp. of Redmond, Wash., USA. The cloud service 514 provides various applications which can be accessed and delivered to, for example, personal computers 506, portable computing devices such as computer tablets 508, personal digital assistants (PDAs) 510 and cellular devices such as telephones and smart phones 512. For example the cloud service 514 may provide and support the enterprise applications in association with the feature server 500. The cloud service 513 may also facilitate the delivery of content to user/players by supporting updates and advertising through the enterprise applications to the remote device user/player. The cloud service 514 includes security provide for secure communication with the cloud service 514 between the player/users and the cloud service 514 and between the cloud service 514 and the gaming enterprise system 501. Security applications may be through encryption, the use of personal identification numbers (PINS), biometric identification, location determination or other devices and systems. As suggested in FIG. 5 the cloud service 515 stores or accesses player/user data retrieved from players/users and from the gaming enterprise system 501 and feature server 500.

The players/users may access the cloud service 514 and the applications and data provided thereby through the Internet or through broadband wireless cellular communication systems and any intervening sort range wireless communication such as WiFi. The players/users may access the applications and data through various social media offerings such as Facebook, Twitter, Yelp, MySpace or LinkedIn or the like.

As but an example, a player/user may have a player account with a casino enterprise. That account may include data such as the player's credit level, their rating and their available comps. At their smart phone 512 the player/user sends a request to the cloud service 514 (perhaps through a previously downloaded application) to request a the status of their available comps such as how many comp points they have and what may be available through redemption of those points (e.g. lodging, cash back, meals or merchandise). The application for the request may present casino promotions, graphics or other advertising to the player/user. The application, to support such a request, would typically require the player/user to enter a PIN or some other unique identifier such as a biometric identifier or tag. The cloud service 514 forwards the inquiry to the feature server 500 which, in turn, confirms the identification and retrieves the requested information from the data warehouse 835 or player history database 857 or player tracking CMS/CMP server 837. The information is formatted by the cloud service 514 application and delivered to the player/user. The delivery may be formatted based upon the player/user's device operating system (OS), display size or the like.

The cloud service 514 may also host game applications to provide virtual instances of games for free, promotional, or where permitted, P2P (Pay to Play) supported gaming. Third party developers may also have access to placing applications with the cloud service 514 through, for example a national operations center (Bally NOC 504). A game software manufacturer such as Bally Gaming, Inc. may also provide game applications on its own or on behalf of the casino enterprise.

Other media such as advertising, notices (such as an upcoming tournament) promotions and surveys may also be provided to and through the cloud service 514. When a player/user accesses the cloud service 514 certain media may be delivered to the player/user in a manner formatted for their application and device.

The cloud service 514 enables the casino enterprise to market to and foster player loyalty. To drive such interaction various incentive programs may be employed including, as described above, users earning or being awarded mystery game chances which may be redeemed at their next visit to the casino enterprise or, where permitted, during play on their remote devices.

As stated above, the present invention is directed to systems and methods for providing mystery awards to players. In one embodiment of the present invention a system and method are set forth for providing a Bingo themed mystery bonus game. FIG. 6 shows an example or architecture for implementing this embodiment. Gaming devices 10 are shown and represent a plurality of such devices. The casino enterprise may connect all of its gaming devices 10 to the system for bonusing or may select a subset to participate. This selection may be made when the system is configured or may be managed on the fly so that the casino or operating conditions can take devices from or add devices to the bonus system as desired. Each gaming device 10 is connected through a DM 1000 (and/or PTM 28) and the network bus 825 to the SMS 805 (FIG. 4A) to provide system communication between the gaming devices 10 and the SMS 805. As stated above the DM 1000 is configured as is described in U.S. Pub. App. 2009/0149253 entitled “Video Switcher and Touch Router Method for a Gaming Machine” filed Jan. 8, 2009 which has been incorporated by reference. Compared to the PTM 28 the DM 1000 is configured to arrange, for example, the primary display 14 to display both game content and content delivered from the system over the network thus dispensing with the need for the separate PTM display 30. It should be understood that the DM 1000 and PTM 28 could be replaced with alternate system communication devices. The gaming devices 10 communicate with the DM 1000 through a SAS (slot accounting system) protocol from IGT® of Reno, Nev. and as is known in the art. The DMs 1000 may communicate with the SMS 805 using SDS free-form protocol as provided by Gaming Standards Association of 48377 Fremont Blvd., Suite 117, Fremont, Calif. 94538.

BCC (Bally Configuration Center) 830 communicates with the DMs 1000 to provide display content to the gaming devices 10 such as system content which may be unrelated to the delivery of the bonus game. Content may be displays associated with the player's account, advertising, promotions or the like. BCC 830 may also download mystery bonus game presentation schema to the DM 1000 for display winning or losing bonus outcomes as hereinafter described. Communication between the DMs 1000 and the BCC 830 may be as per the GSA G2S standard protocol.

The SMS 805 is in communication with a mystery bonus service 832 which receives from the DMs 1000 (or other slot accounting system) data corresponding wagers, denomination, base game play prompts, the purchases of mystery game instances as well as for metering events related to the location/identity associated with the purchases, “tilt” events such as failures and the like. The mystery bonus service 832 may be a software module provided in an existing server at the casino enterprise or on separate server. The communications between the SMS 805 and mystery bonus service 832 may be through the GDS protocol as provided by Gaming Standards Association. SMS 805 is configured to determine the gaming machine (such as though its network address, MAC address, assigned machine number), the wager amount made to play the base game, game credits which may reside on the gaming device, the machine's configuration (denomination, e.g. a $0.01, $0.25, $0.50, $1.00, $5 wager credit increments) as well as the number of secondary mystery bonus game instance purchases. For purposes of this description the wager amount to play the base game will be designated as “w”. It should be noted that wagers w can be in various amounts. As but an example, on a $0.01 denomination gaming device slot machine having five reels and fifty pay lines, the player may wager w from $0.01 to $5.00 depending upon the number of lines and wagers per line.

The mystery bonus service 832 is in communication with the progressive service 834, shown as the Bally Elite Progressive Suite (“BEPS”). The progressive service 834 may be a software module provided in an existing server at the casino enterprise or on separate server or hosted at a remote location perhaps by the third party. The mystery bonus service 832 receives from the DMs 1000 data corresponding to the amounts w wagered on the base game and amounts wagered to enable additional instances of the mystery bonus game as hereinafter described for assembling one or more progressive awards. The mystery bonus service 832 is also configured to determine if a mystery prize award has been triggered, to determine the prize amount to be awarded and to trigger at least a message in response to win determination as hereinafter described for delivery of a winning or losing outcome display sequence to the players as well as prize information.

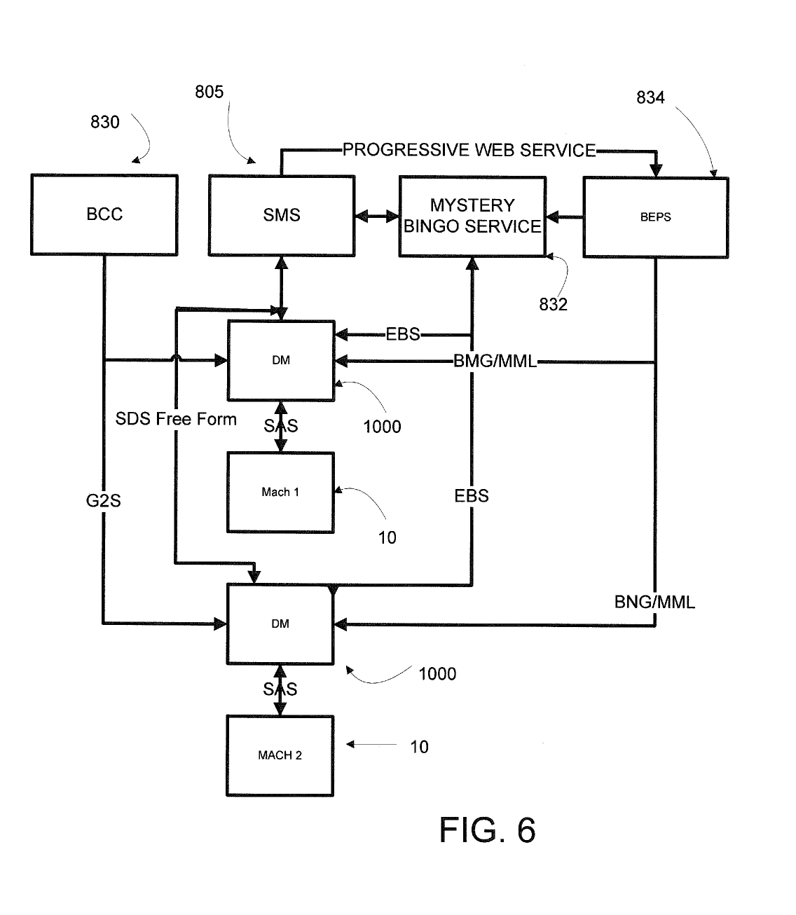

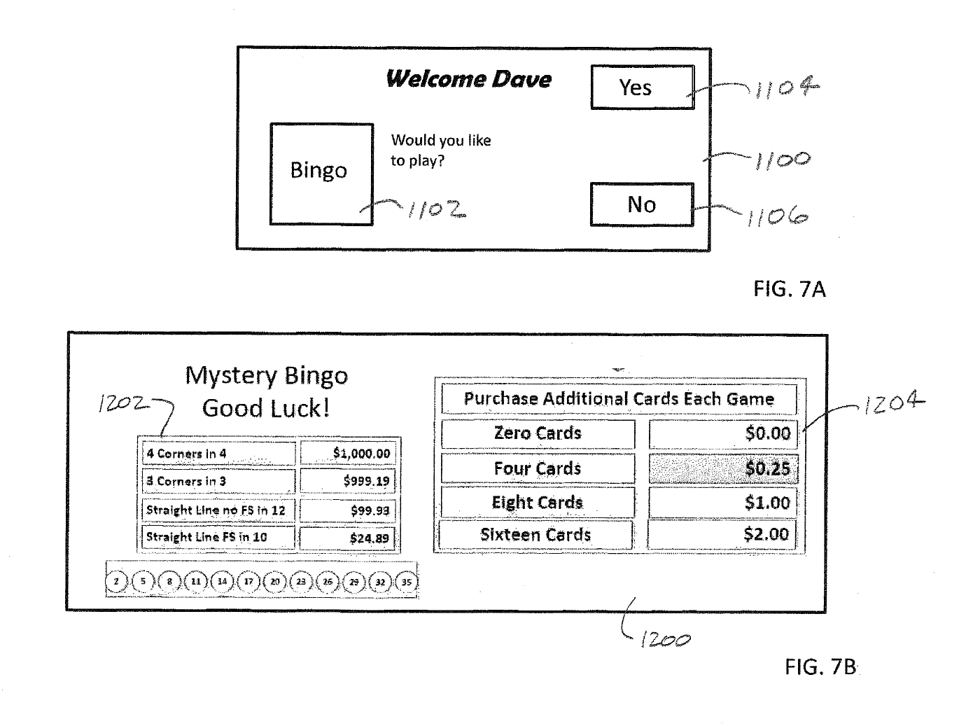

In an implementation of the present invention, the bonusing service 832 may be configured to provide one or more instances of a Bingo card presentation for delivering a mystery bonus award. FIG. 7A shows an example of a display 1100 offering the player an opportunity to participate. This display may be presented at the PTM display 30 or, where a DM 1000 is provided, at real estate at the primary or secondary game displays 14, 18. A mystery game icon 1102 may be displayed to tell the player the nature of the game. In one embodiment participation may be universal, i.e. the player has no choice to opt in or out of the mystery game. According to this exemplary embodiment the player is given the choice to participate in the game. If the player chooses to participate he/she would select a “yes” option 1104. If the player decides to opt out, the player would select the “no” option 1106. Participation in the game has several aspects. In a preferred embodiment all players of participating of gaming devices 10 are required to participate and have no option to opt out of the mystery game.

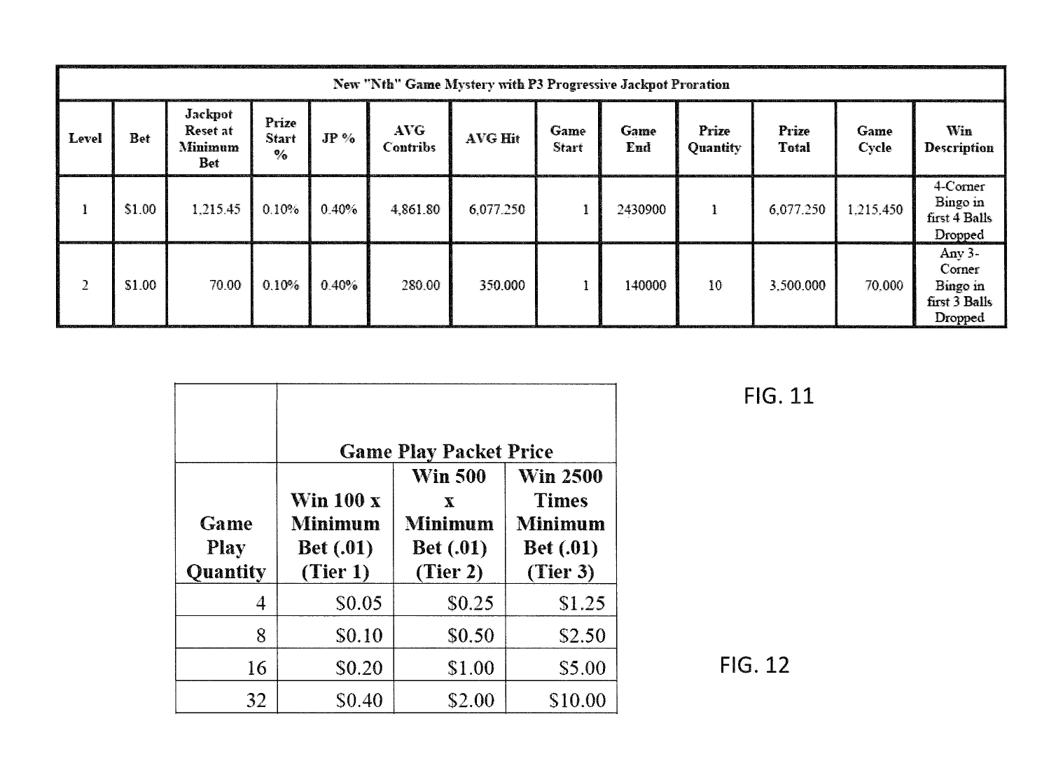

In an embodiment initial participation provides at least an initial instance of the game Bingo card funded by a portion of the player's wager w at the base game. According to this embodiment participation would be automatic and the option to elect not to play would not be offered. With reference to FIG. 11, the funding architecture for the initial mystery game entry/instance is shown in connection to a Bingo mystery game where two Levels of mystery awards are available: the Level 1 prize is associated with the odds (O) of the first four Bingo balls drawn matching the four corners of a Bingo card (1:1,215,450) and the Level 2 prizes are associated with the odds (O) of the first three Bingo balls drawn matching any three corners of a Bingo card (1:70,000). For the Level 1 prize structure there is only one prize and for Level 2 there are 10 prizes. The table of FIG. 11 is based upon an assumed gaming device 10 population maximum wager of $1. This means that of all the machines contributing to this mystery game, the maximum base game wager which can be made on any machine is $1. It should be understood that the population max bet of $1 is selected for purposes of showing the mystery architecture and not by way of limitation. Assuming that a player makes a $1 wager, 0.10% (0.1¢) is contributed to seed the next Level 1 jackpot (i.e. the reset value) and 0.10% (0.1¢) is contributed to seed the next Level 2 jackpot (i.e. the reset value). Level 1 has an expected reset value of $1,215.45 and Level 2 of $70.00. In addition to funding the reset values, and as shown in column 3 of FIG. 11, for the $1 wager, 0.40%, (0.4¢) is contributed to the current Level 1 jackpot pool and the same amount is contributed to the current Level 2 jackpot pool. Thus for the $1 wagered a total of 1¢ is contributed to fund the current jackpot pools and the start-up (reset or seed) for the next jackpot pools.

In one embodiment the mystery trigger is based upon the number of Bingo game instances played reaching a trigger value. The true odds (O) of the event occurring establish as game cycle, i.e. how many Bingo draws would be expected before the jackpot outcome is obtained. The trigger value in this embodiment is randomly selected resulting in, over time, the number of plays matches the game cycle. Accordingly the trigger is randomly selected between 1 and 2×O resulting in, over time, the number of draws until the jackpot matching the game cycle. The table of FIG. 11 reflects the game cycles or odds O for the Level 1 and Level 2 jackpots and sets the number of games to jackpot as the “Game End” of 2×O or, for Level 1 as 2,430,900 and for Level 2 as 140,000. Over numerous iterations the trigger values of game instances played randomly selected between 1 and 2×O will be 2×O/2; or the game cycle value (O). To complete the table of FIG. 11, assuming the trigger is selected at O, the jackpot pool will be funded when it hits at $1,215.45=(its start-up value)+0.004 (funding rate based upon a $1 base game bet)×1,215,450 (number of games to trigger)=$6,077.25. Assuming the random number trigger is selected as O (random number selected between 2×O, or 2×O/2=70,000 games played the Level 2 jackpot pool will be funded to an amount of $70.00 (its start-up or seeded value)+0.004×70,000=$3500 when, theoretically, a Level 2 jackpot is hit.

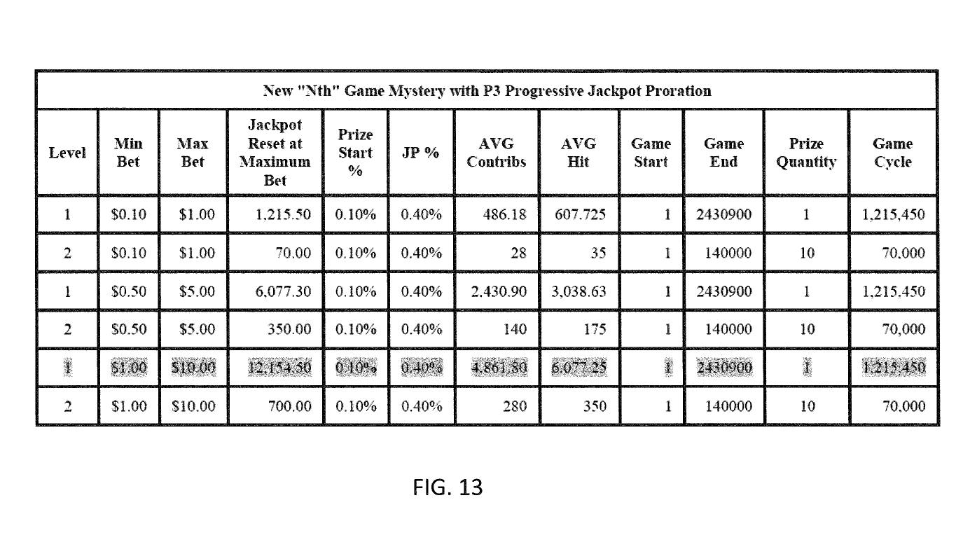

The table shown in FIG. 13 shows the jackpot accumulation and awards for Levels 1 and 2 for various base game population max bet amounts. In rows 1-2 of the table of FIG. 13 is seen an arrangement for a mystery jackpot link for gaming devices where players can make a minimum bet of $0.10 to a game population max bet of $1 (the maximum wager for any gaming device on the link). Columns 1-2 show those bet ranges and column 3 shows the jackpot reset value based upon the population max bet of $1 (same as FIG. 11) the percentage allocations are the same as was in FIG. 11 as are the game end, prize quantities game cycle and game start figures. However, the table of FIG. 13 illustrates how base game wagers less than the population max bet would contribute to the pool, and be bonused. As can be seen from columns 7-8 at the minimum bet of 10¢, the AVE Contribs (average contribution) is 1/10 of that of FIG. 11 inasmuch as the wager is 1/10 of the population max bet. Also the average bonus for Level 1 when hit would 1/10 that of FIG. 11, or $607.73. The Level 1 and 2 average awards as set forth in rows 3-6 for bonus links having minimum and population max bet of 50¢ and $5 and $1 and $10. Columns 7-8 show average contribution and award (hit) values for minimum link bets.

According to this embodiment the mystery bonus may be configured as follows:
O=the odds of the jackpot outcome occurring
Game End (a number representing the end of a range of numbers)=2×O
Prize reset (seed) contribution from base game bet to re-seed the next
Progressive pool start-up value=0.10% (selected)
Current Jackpot pool contribution from base game bet=0.40% (selected)
AVG Contribs to pool when hit=0.40%×(2×O/2)(Average number of games until trigger)
Award to player=Gross Prize Value×(Winning Game Instance Bet Amount)/(population max bet) where, Gross Prize Value is the amount of the applicable jackpot pool (the Jackpot Reset Amount+Total contributions to the current pool when triggered less any prior jackpot award amounts) and the Winning Game Bet Amount is the player's wager at the base game for the winning game instance.

Where a player wagers less than the maximum population wager, they still participate in the mystery game and receive the initial game presentation instance; however their award would be in proportion to the maximum population bet.

Turning to FIG. 12 a feature of the present is to enable players to purchase instances of the bonus game in addition to the initial bonus game instance provided with the wager w on the base game play. In an embodiment the players may be offered continuously, upon the occurrence of a certain event (such as a winning outcome in the base game) or at intervals the opportunity to purchase additional instances of the bonus game. For example the player may be offered several tiers for purchasing additional instances, each tier requiring greater consideration, i.e. wager, per mystery game instance and entitled to a greater portion of the pool. For the lowest tier (Tier 1) the player may purchase four (4) additional instances of mystery game Bingo cards for a wager of $0.05, where each instance has a wager of 1¢ allotted to it and 1¢ is allotted for a 20% profit. Assuming that one of the instances purchased for 1¢ is a winning instance and the population max bet is $1 (FIG. 14) the player would win 1¢/(population max bet)=1¢/$1= 1/100th of the current jackpot pool and the pool value would be reduced by the pay out.

If the player selected to make a Tier 2 purchase of a group of four mystery Bingo instances, each instance purchase would be for 5¢ (=20¢) with another 20% (5¢) being allocated for profit to the hosting enterprise. If one of these instances was deemed to be the winning instance it would be paid a portion equal to 5¢/(population max bet). Thus if the population max bet for the network is $1, the player would be paid 5% of the current jackpot pool or 500% over the pay for a Tier 1 wager. Tier 3 represents a purchase of four instances for a wager of 25¢ each with another 25¢ allocated for profit. Again the player. if one of these additional instances is deemed to be the winning card, would receive 25¢/(population max bet) or 2500% over the pay for a Tier 1 wager.

FIG. 12 continues for other groups of mystery Bingo game instances which may be purchased for Tiers 1-3. As can be appreciated player may buy additional groups of up to thirty-two game instances. The consideration paid for these purchases may come from the gaming device credit meter, a player electronic fund transfer (EFT) from a player account, use of a voucher, use of promotional credits/player points or by, for example, the player paying with cash as by inserting cash into the cash validator for the gaming device. In a feature of the present invention the ability for the player to use promotional credits/player points provides for players to redeem and retire earned promotional credits/points. This, as described above, reduces the casino's carried liability for those credits/points. The gaming enterprise may provide promotional vouchers/credits to players which may be dedicated to the player's purchase of mystery game instances.

Additionally the casino enterprise may provide the right to acquire second game instances through promotions. For example, the casino at their website or social network site may provide promotions which include the right to enable, upon a next visit to the casino, second game instances. The promotion may be for the player voting to “like” the casino on Facebook, in exchange for participating in surveys, as awards for the play of promotional games, for using the site to book rooms or the like. Data representing the “right” would be provided to the user's account. On the next visit to the casino the player, through the use of their player card and accessing their account, could redeem the right and enable additional instances of the mystery game.

FIG. 7B is an example of a display 1200 which may be delivered to the player should they desire to play the mystery Bingo game. As described above, participation in the mystery may be mandatory for at least the base game wager based mystery game instance. At 1202 there is displayed the winning outcome and award levels. According to this embodiment four winning outcomes are provided: Four corners of a Bingo card matching the first four Bingo balls drawn, three corners in the first three Balls drawn, a straight line Bingo with no “Free” square in the first twelve Bingo balls drawn and a straight line Bingo including the “Free” square in the first ten Bingo balls drawn. The award values associated with at least the top level outcomes (highest awards), according to this embodiment, are progressive and hence grow based upon the progression of the associated pools. In the embodiment shown, all four winning outcomes are associated with their progressive pools. The awards may each have their own progressive pools funded by portions of wagers and purchased game instances.

At 1204 there is shown a Tier 2 purchase schedule for purchasing additional mystery Bingo game instances as described above in connection with FIG. 12. Should the player wish to acquire additional games instances they would select the desired number of instances and provide the required consideration as by paying with base game credits from the credit meter, using electronic funds, a voucher, promotional value (player points, comp points) or inserting value such as currency or coins.

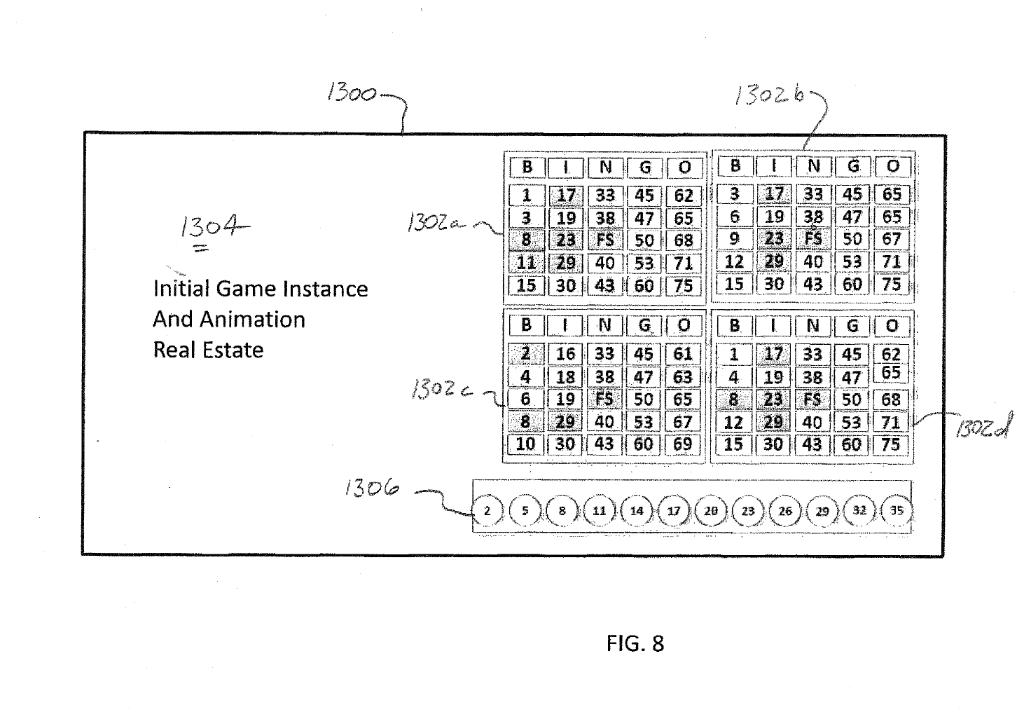

FIG. 8 illustrates a display 1300 showing, for example, a set of four purchased game instances 1302a-d as well as a location 1304 to show the initial mystery Bingo game instance (not shown) and game animation such as a Bingo ball hopper selecting Bingo balls. A panel 1306 may show Bingo balls for the outcome. It should be noted that the mystery is determined as described above and that the Bingo game instances are used to display winning or losing outcome. That is, the game outcome according to this embodiment, is not based upon an actual Bingo draw but instead upon a mystery game and a detected trigger condition. Once it is determined that there is no mystery win, the display 1300 is controlled to display losing outcome(s) for all game instances. If a winner is determined the display 1300 is controlled to display a win at the winning Bingo game instance, i.e. the game instance which caused the game cycle, i.e. number of game instances played, to reach the trigger value.

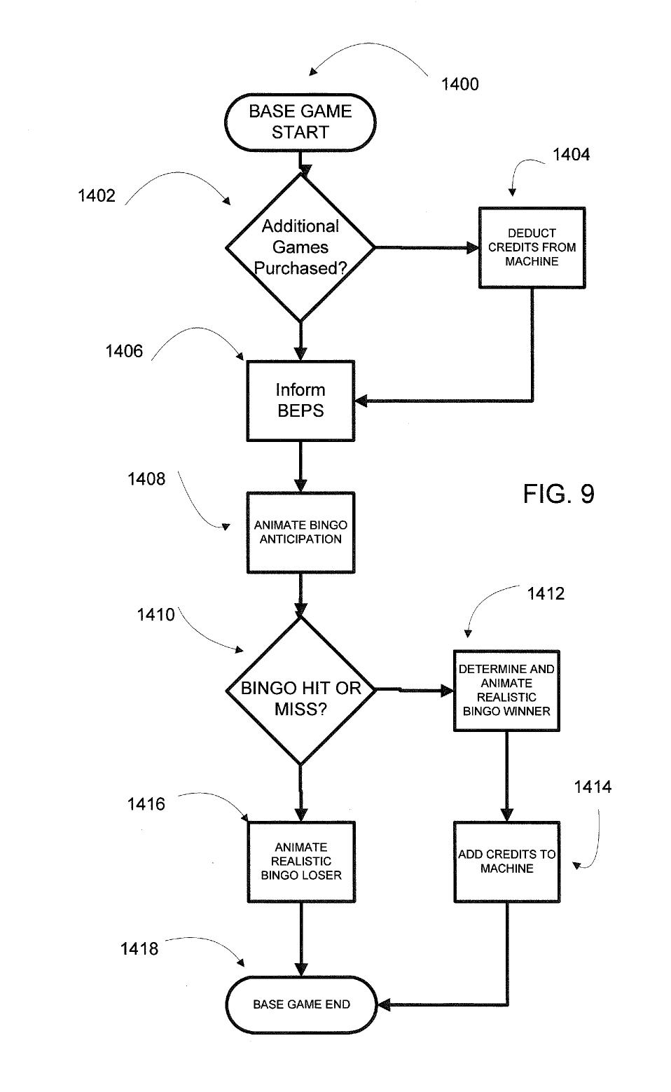

After the player has selected the number of additional game instances they wish to purchase, the player initiates play of the base game. The base game play initiation enables the base game funded initial Bingo instance as well as starts the determination of whether or not the player has a mystery winning outcome. The player can also select to automatically play their additional enabled instances for sequential base game plays until those instance are disabled by the player. For example, the player may purchase four additional, second game instances which will be automatically funded from credits at the gaming machine. For each base game play all enabled instances are played and credit value is deducted. FIG. 9 there is shown a logic diagram for the operation of the mystery game. At 1400 the player prompts play of the base gaming at the gaming device 10. At 1402, if the player has elected to purchase additional games that is determined at 1402 and at 1404 the consideration for the additional games is deducted from the gaming device credit meter and at 1406 the number of purchased games and their price is sent to the progressive service 834 (FIG. 6). Either from a local source such as the DM 1000 or streamed from the mystery bonus service 832 at 1408 the display is controlled to display anticipation graphics for example at location 1304. The bonus service 832 also determines at 1410 whether the player's game instances have triggered an award. If any of player's instances have resulted in a trigger condition being met, at 1412 the bonus service 832 issues a signal representing that a trigger has occurred (and data representing the amount of the award) to, for example, the DM 1000 for the winning gaming device 10 to control the display to animate the corresponding winning Bingo outcome. At 1414 the award is added to the gaming device 10 credit meter. On the other hand, if there is not winning game instance and the DM 1000 does not receive a “win” signal from the bonus service 832 within a period of time, at 1416 the DM 1000 controls the display to display losing outcomes. At 1418 the bonus game sequence is ended. The same process is followed for the next base game play.

By having the local DM 1000 store data to present winning and losing outcomes, network traffic is not burdened. The bonus service 832 only sends a signal to the local DM 1000 when a trigger has occurred. If the DM 1000 does not receive the trigger notification within a period of time representing the play of the game, it simply controls the display to display losing outcomes.

Alternatively winning and losing animation (or video) sequences could be streamed to the gaming device 10 display. Still further the animation and notification could be a shared function between the DM 1000 and bonus service 832.

Upon issuance of an award, the same is deducted from the relevant pool and at 1202 the display is refreshed to reflect the new pool values. If a player has won the entire amount for the pool (i.e. played the mystery at a max population bet amount and triggered the award pool) the pool is re-set to the seed pool amount and the seed pool is restart at its start amount.

The foregoing embodiment describes the present invention in connection with a game instance count trigger, i.e. the win is trigger when the number of played instances reaches the trigger count. However, other triggers may be used. In one embodiment for each base game play prompt a lottery draw is conducted. As but an example, for each base game play prompt the bonus server may randomly select a number between 1-X (where X may be O or 2×O) and if the number is “1” the award is triggered. To handle additional; game instances the bonus service may draw a number for each enabled game instance. This routine may continue unit the number “1” is drawn, or a predetermined limit of draws is reached, i.e. O draws. To increase the odds the limit (O or 2O) may be reduced by the number of game instances played. Thus the odds would increase with each successive draw. When the trigger is reached, the award may go to the game instance associated with the trigger or the bonus service may randomly select a winning instance.

Another trigger may be based upon Class II gaming where O Bingo outcomes are selected and stored at a data structure. One outcome would represent the top prize, others the designated smaller awards and the remainder losing outcomes. The outcomes may be randomly distributed. For each instance played, an outcome is selected and depleted from the data structure. If a wining outcome is selected, a winning animation is displayed and the award is issued.

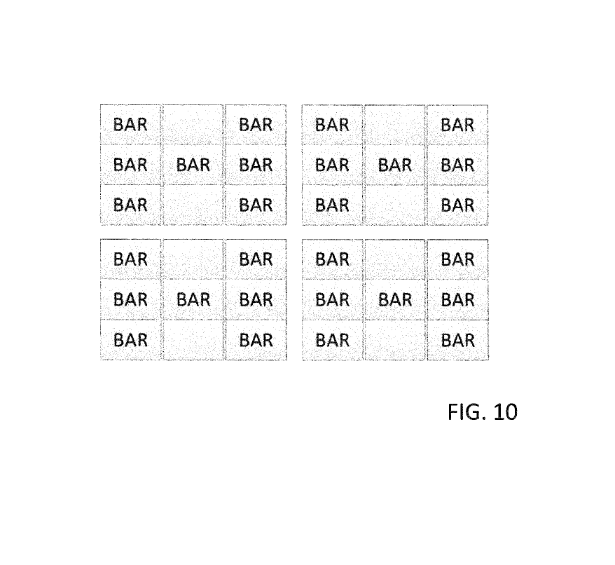

FIG. 10 shows an embodiment where the mystery game instances are a slot machine game display. As with Bingo embodiment, the player receives a first game instance with the play of the base game and may purchase additional instances. If a winning trigger occurs the display is controlled to display one or more wining outcomes.

The mystery game instances could be any game or event. The player may enable Poker hand mystery game instances where, for example, the top prize is reflected by a display of Royal Flush. Keno, Roulette, Craps or other wagering games could be used. For example, where horse racing may the mystery presentation game-type, the player may receive/purchase instances of a number of horse selections to finish in order in a race. As but an example, the player may receive with the play of the base game, horse numbers “7, 11, 6 and 5” and may purchase other instances (for which either the numbers are randomly assigned or selected by the player) of numbers. If a mystery trigger occurs, the mystery display is controlled to display the horses for the designated winning instance finishing in order, i.e. “7, 11, 6 and 5”. Other sporting event may be used such a baseball where the player obtains one pitch to their batter but can acquire additional pitches and if a trigger condition occurs the designated winning pitch is hit for a home run.

As an alternative to a mystery trigger, the mystery bonus service 832 may instead be configured to actually run a Bingo draw of numbers for each play. That is, when a player prompts play a virtual, random Bingo draw is conducted and if the predetermined outcomes (i.e. 4 corners in 4 the first four balls drawn, etc.) as described above occur then said awards are issued. The controller would randomly draw Bingo numbers, which draw may be confined to a predetermined number, and if an enabled Bingo card has number matches defining a predetermined award triggering pattern, e.g. 4 corners, an award is triggered. In this fashion the mystery award is based on an actual, virtual Bingo draw.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

We claim:

1. In an environment including a plurality of gaming devices each including a display and configured for the play of one or more base games as displayed at said display and a communication network, a system for providing a mystery bonus award to a player comprising:
a mystery bonus host computer and associated data structure, said host computer in communication with said gaming devices and enabling a first instance of a mystery game presentation displayed at said display or a secondary display;
a player input device in communication with said host computer over said network, said input device configured to enable players to establish one or more second instances of a mystery game presentation for display at said one or more displays in exchange for payment of consideration;
said host computer and data structure configured to receive over said communication network data corresponding to any of an enabled instance, the associated gaming device and a mystery award trigger condition;
said mystery host computer configured to (i) receive a signal in response to game play prompts from each gaming device and in response to receipt of said signal determine if a mystery award trigger condition has been satisfied and (ii) if said trigger condition has been satisfied to (a) determine a winning gaming device, (b) allocate an award to a winning gaming device and (c) send a signal to cause said display to display a winning outcome video sequence for at least one game instance at said winning gaming device; and
where said trigger condition has not been satisfied said displays controlled to display losing outcome video sequences for each instance of said mystery game presentation.

2. The system of claim 1 comprising said mystery host configured to randomly set said trigger condition as an aggregate number of mystery game instances Z enabled at said gaming devices, to count said enabled mystery game instances received play prompts and determine a winning gaming device as the device whose enabled mystery game instance caused said count to substantially reach Z.

3. The system of claim 2 comprising said mystery game presentation is a presentation of a gambling game having an outcome with odds O of occurring, said host computer configured to randomly select an enable mystery game instance trigger of Z where 1≦Z≦(2×O).

4. The system of claim 1 comprising said player input device configured to enable players to establish groups of second instances of a mystery game presentation for display at said one or more displays in exchange for payment of consideration.

5. The system of claim 4 comprising said player input device configured to enable a player to pay a consideration for a group of second instances of a mystery game presentation.

6. The system of claim 1 comprising said player input device configured to provide for the player to pay consideration from one or more sources selected from the group consisting of funds available at said gaming device, a deposit of funds, a coupon, a voucher, electronic funds available though said network or promotional funds provided to the player.

7. The system of claim 1 comprising said enabled game instance is selected from a group consisting of a Bingo card presentation, a Keno card presentation, a Poker hand presentation, a slot machine display presentation, a lottery ticket presentation and a sporting event presentation.

8. The system of claim 1 where the gaming devices are devices which accept a wager to play a base game comprising said host computer configured to (a) aggregate a fund pool from at least a portion r of said consideration paid by players, and (b) select a mystery bonus trigger as a pool value.

9. The system of claim 1 where said host computer is configured to define a pool of numbers and a trigger number T and for each game play prompt from a gaming device select a number N from the pool for each mystery game instance at said gaming device and if N=T determine that said trigger condition has been satisfied.

10. The system of claim 9 comprising said host computer configured to define said pool of numbers as 1-P.

11. The system of claim 10 comprising said host computer configured to select T=1.

11. The system of claim 9 comprising said host computer configured to deplete said pool of numbers based upon the numbers selected.

12. The system of claim 1 comprising a local controller at one or more gaming devices, said local controller providing communication between said gaming device and said network and host computer, said local controller configured to store data for controlling said one or more displays to display at least one of said winning and losing outcomes.

13. The system of claim 12 comprising said host computer configured to issue a bonus award signal to the controller of the winning gaming device to control said controller to display a winning outcome, said controller for other plays controlling said one or more displays to display a losing outcome.

14. In an environment including a plurality of gaming devices each including apparatus for accepting a wager w, a display and configured for the play of one or more base games as displayed at said display and a communication network, a system for providing a mystery bonus award to a player comprising:
a mystery bonus host computer and associated data structure, said host computer in communication with said gaming devices and enabling a first instance of a Bingo card presentation displayed at said display or a secondary display in response to placing a wager w;
a player input device in communication with said host computer over said network, said input device configured to enable players to enable one or more second instances of a Bingo card presentation in exchange for payment of consideration;
said host computer and data structure configured to receive over said communication network data corresponding to each enabled Bingo card presentation, the associated gaming device and to store and determine an award trigger condition;
said mystery host computer configured to (i) receive a signal in response to game play prompts from each gaming device and in response to receipt of said signal determine if a mystery award trigger condition has been satisfied and (ii) if said trigger condition has been satisfied to (a) determine a winning gaming device, (b) allocate an award to a winning gaming device and (c) send a signal to cause said display to display a winning outcome video sequence for at least one enabled Bingo card presentation at said winning gaming device; and
where said trigger condition has not been satisfied said displays controlled to display losing outcome video sequences for each instance of said enabled Bingo card presentation.

15. The system of claim 14 comprising said mystery host configured to randomly set said trigger condition as an aggregate number of enabled Bingo card presentations Z at said gaming devices, to count plays of said enabled Bingo card presentations and determine a winning gaming device as the device whose play prompt included an enabled Bingo card presentation causing said count to substantially reach Z.

16. The system of claim 15 wherein a predetermined Bingo outcome has odds O of occurring, said host configured to randomly select Z where 1<Z≦(2×O).

17. The system of claim 14 comprising said player input device configured to enable a player to pay a consideration for a group of Bingo card presentations.

18. In an environment including a plurality of gaming devices each including apparatus for accepting a wager w, a display and configured for the play of one or more base games as displayed at said display and a communication network, a method for providing a mystery bonus award to a player comprising:
configuring a mystery bonus host computer and associated data structure for enabling a first instance of a Bingo card presentation to be displayed at said display or a secondary display in response to placing a wager w;
enabling players to establish one or more second instances of a Bingo card presentation in exchange for payment of consideration c;
said host computer and data structure receiving over said communication network data corresponding to (i) each enabled Bingo card presentation, (ii) the associated gaming device;
determining an award trigger condition;
said mystery host computer receiving a signal in response to game play prompts from each gaming device and in response to receipt of said signal determining if a mystery award trigger condition has been satisfied and if said trigger condition has been satisfied determining a winning gaming device, allocating an award to a winning gaming device and sending a signal to cause said display to display a winning outcome video sequence for at least one enabled Bingo card presentation at said winning gaming device; and
where said trigger condition has not been satisfied controlling the displays to display losing outcome video sequences for each instance of said enabled Bingo card presentation.

19. The method of claim 18 comprising determining said trigger condition based upon the aggregated sum of Bingo card presentations played.

20. In an environment including a plurality of gaming devices each including a display and configured for the play of one or more base games as displayed at said display and a communication network, a system for providing a mystery bonus award to a player comprising:
a mystery bonus host computer and associated data structure, said host computer in communication with said gaming devices and enabling a first instance of a Bingo card presentation displayed at said display or a secondary display;
a player input device in communication with said host computer over said network, said input device configured to enable players to establish one or more second instances of a Bingo card presentation for display at said one or more displays in exchange for payment of consideration;
said host computer and data structure configured to receive over said communication network data corresponding to any of an enabled instance, the associated gaming device and Bingo award condition; and
said mystery host computer configured to (i) receive a signal in response to game play prompts from each gaming device and in response to receipt of said signal randomly select Bingo numbers and if one or more predetermined numbers on an enabled Bingo card presentation match the selected Bingo numbers and define a predetermine pattern on a said enabled Bingo card determine that an award trigger condition has been satisfied and (ii) if said trigger condition has been satisfied to (a) determine a winning gaming device, (b) allocate an award to a winning gaming device and (c) send a signal to cause said display to display a winning outcome video sequence for at least one game instance at said winning gaming device.
